(19) United States
(12) Patent Application Publication
(10) Pub. No.: US 2007/0137751 A1
(43) Pub. Date: Jun. 21, 2007

(54) Vehicle anti-theft device

(76) Inventors: Jui-An Tsai, Tainan City (TW); Chung-Hsing Hsieh, Tainan Hsien (TW)

Correspondence Address: DARBY & DARBY P.C., P. O. BOX 5257, NEW YORK, NY, 10150-5257, US

(21) Appl. No.: 11/305,414

(22) Filed: Dec. 16, 2005

(51) Int. Cl. B60C 29/00

(52) U.S. Cl. 152/415

(57) ABSTRACT

An anti-theft device is provided for a vehicle having a wheel axle and a vehicle wheel that includes a wheel rim coupled co-rotatably to the wheel axle, and a pneumatic tire mounted on the wheel rim. The anti-theft device includes a tire-deflating unit and a deflation controller. The tire-deflating unit is adapted to be coupled to the vehicle wheel, and is operable in a deflating state for deflating the pneumatic tire. The deflation controller is coupled to the tire-deflating unit, and is operable in an activated state, in which the deflation controller detects movement of the vehicle and enables operation of the tire-deflating unit in the deflating state upon detecting movement of the vehicle.

### BACKGROUND OF THE INVENTION

1. Field of the Invention

The invention relates to an anti-theft device, more particularly to a vehicle anti-theft device.

2. Description of the Related Art

While there are many types of vehicle anti-theft devices currently available to vehicle owners, the anti-theft effects thereof are generally poor in view of incessant reports of vehicle theft. In general, most conventional vehicle anti-theft devices still permit thieves to move stolen vehicles after defeating the anti-theft mechanisms of such devices.

### SUMMARY OF THE INVENTION

Therefore, the object of the present invention is to provide an anti-theft device that can overcome the aforesaid drawback associated with the prior art.

According to the present invention, there is provided an anti-theft device for a vehicle having a wheel axle and a vehicle wheel that includes a wheel rim coupled co-rotatably to the wheel axle, and a pneumatic tire mounted on the wheel rim. The anti-theft device comprises a tire-deflating unit and a deflation controller.

The tire-deflating unit is adapted to be coupled to the vehicle wheel, and is operable in a deflating state for deflating the pneumatic tire.

The deflation controller is coupled to the tire-deflating unit, and is operable in an activated state, in which the deflation controller detects movement of the vehicle and enables operation of the tire-deflating unit in the deflating state upon detecting movement of the vehicle.

### BRIEF DESCRIPTION OF THE DRAWINGS

Other features and advantages of the present invention will become apparent in the following detailed description of the preferred embodiments with reference to the accompanying drawings, of which:

FIG. 1 is a fragmentary perspective view of a vehicle installed with the first preferred embodiment of an anti-theft device according to the present invention;

FIG. 2 is a simplified schematic top sectional view of the first preferred embodiment, illustrating a tire-deflating unit thereof in a non-deflating state;

FIG. 3 is a schematic diagram to illustrate a response module of a deflation controller of the first preferred embodiment;

FIG. 4 is an enlarged perspective view of the tire-deflating unit of the first preferred embodiment;

FIG. 5 is a view similar to FIG. 2, but illustrating the tire-deflating unit in a deflating state;

FIG. 6 is a fragmentary perspective view of a vehicle installed with the second preferred embodiment of an anti-theft device according to the present invention;

FIG. 7 is a schematic top sectional view of the second preferred embodiment;

FIG. 8 is a schematic partly sectional view to illustrate a tire-deflating unit of the third preferred embodiment of an anti-theft device according to the present invention;

FIG. 9 is a view similar to FIG. 8, but illustrating the tire-deflating unit in a deflating state;

FIG. 10 is a schematic view to illustrate a tire-deflating unit of the fourth preferred embodiment of an anti-theft device according to the present invention;

FIG. 11 is a fragmentary schematic view of a vehicle wheel installed with a tire-deflating unit according to the fifth preferred embodiment of this invention; and

FIG. 12 is a fragmentary schematic partly sectional view of a vehicle wheel installed with a tire-deflating unit according to the sixth preferred embodiment of this invention.

### DETAILED DESCRIPTION OF THE PREFERRED EMBODIMENTS

Before the present invention is described in greater detail with reference to the accompanying preferred embodiments, it should be noted here in that like elements are denoted by the same reference numerals throughout the disclosure.

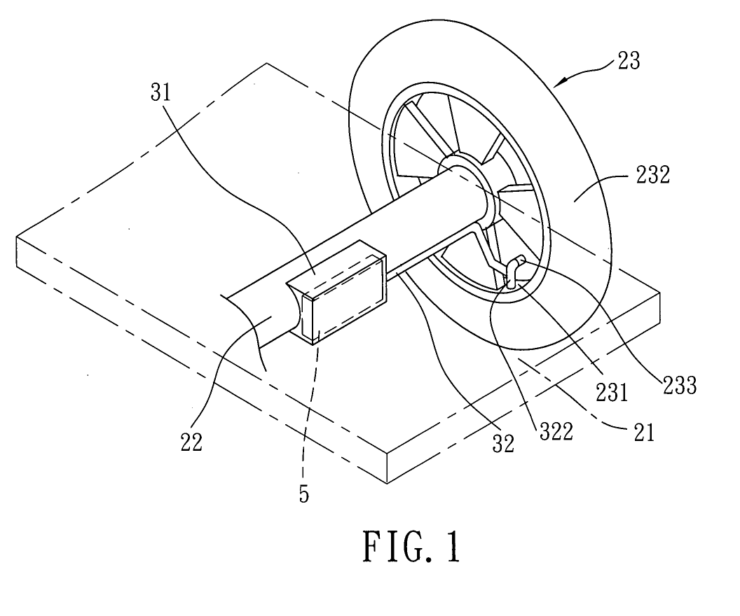

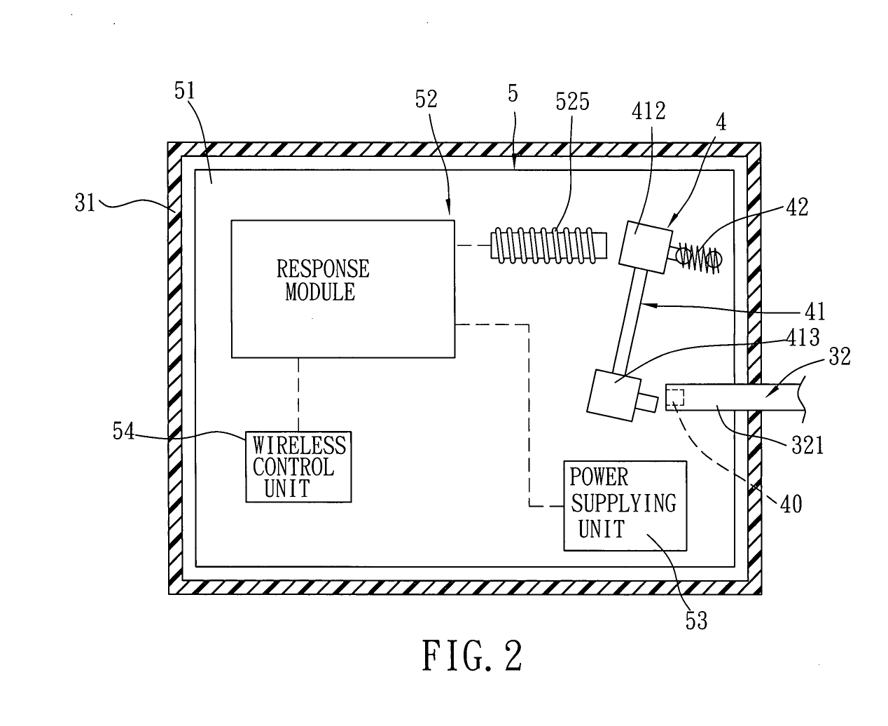

Referring to FIGS. 1 and 2, the first preferred embodiment of an anti-theft device according to the present invention is shown to be adapted for mounting on a vehicle having a chassis 21, a wheel axle 22 mounted rotatably on the chassis 21, and at least one vehicle wheel 23 that includes a wheel rim 231 coupled co-rotatably to the wheel axle 22, and a pneumatic tire 232 mounted on the wheel rim 231 such that the wheel rim 231 and the pneumatic tire 232 cooperate to confine an air-containing space to be inflated via a tire valve

The anti-theft device comprises a casing 31, a tire-deflating unit 4 adapted to be coupled to the vehicle wheel 23 and operable in a deflating state for deflating the pneumatic tire 232, a bypass duct 32 adapted to interconnect fluidly the tire-deflating unit 4 and the pneumatic tire 232, and a deflation controller 5 coupled to the tire-deflating unit 4.

In this embodiment, the casing 31 is a rectangular box that houses the tire-deflating unit 4 and the deflation controller 5 therein and that is adapted to be mounted on the wheel axle 22 so as to be co-rotatable therewith. That is, the casing 31 remains static relative to the wheel axle 22 and the vehicle wheel 23.

In this embodiment, the bypass duct 32 has a coupling end segment 322 adapted to connect the pneumatic tire 232 to the tire valve 233, and an opposite connecting end segment 321 that extends into the casing 31. In other embodiments, the coupling end segment 322 of the bypass duct 32 may be connected to the vehicle wheel 23 at a position independent of the tire valve 233.

The deflation controller 5 is operable in an activated state, in which the deflation controller 5 detects movement of the vehicle and enables operation of the tire-deflating unit 4 in the deflating state upon detecting movement of the vehicle. In this embodiment, the deflation controller 5 includes a circuit board 51, an electromagnet 525 mounted on the circuit board 51, a response module 52 mounted on the circuit board 51, and a power supplying unit 53 (such as a storage battery) mounted on the circuit board 51 for supplying electric power to the deflation controller 5. The electromagnet 525 is capable of being energized so as to generate magnetic forces for operating the tire-deflating unit 4 from a non-deflating state to the deflating state in a manner to be described in greater detail in the succeeding paragraphs. The response module 52 is coupled to the electromagnet 525, and is operable so as to energize the electromagnet 525 in response to movement of the vehicle.

In practice, it is not necessary to dispose the deflation controller 5 in the casing 31 since the former may be disposed in other parts of the vehicle, such as inside a vehicle trunk, under an engine hood, etc. In other words, the presence of the casing 31 is not essential to the present invention.

The deflation controller 5 further includes a wireless control unit 54 mounted on the circuit board 51, coupled to the response module 52, and cooperating with a wireless remote controller (not shown) for controlling activation and deactivation of the response module 52 in response to wirelessly transmitted control signals received thereby. Since the art of remote control is well known, further details will be omitted herein for the sake of brevity.

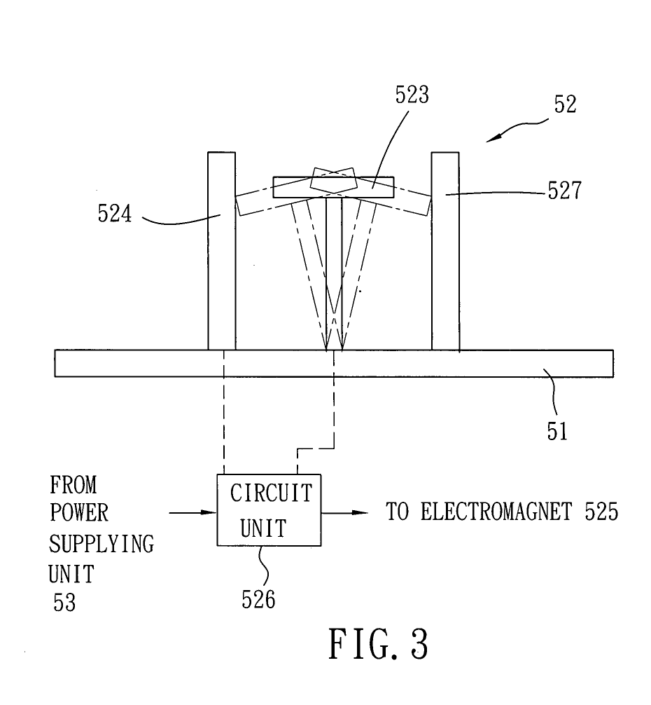

Referring to FIG. 3, in this embodiment, the response module 52 is designed to energize the electromagnet 525 when the response module 52 is subjected to a predetermined number of vibrations during movement of the vehicle. To this end, the response module 52 includes a conductive resilient member 523, a conductive stationary member 524, a limiting stationary member 527, and a circuit unit 526. The conductive resilient member 523 is capable of reciprocating flexing movement when subjected to the vibrations attributed to movement of the vehicle. The conductive stationary member 524 is spaced apart from the conductive resilient member 523, and is intermittently contacted by the conductive resilient member 523 during reciprocating flexing movement of the conductive resilient member 523. The limiting stationary member 527, which may be conductive or non-conductive, is disposed on one side of the conductive resilient member 523 opposite to the conductive stationary member 524, and serves to limit the extent of reciprocating flexing movement of the conductive resilient member 523. The circuit unit 526 is coupled electrically to the conductive resilient member 523 and the conductive stationary member 524, is operable so as to count the number of intermittent contacts between the conductive resilient member 523 and the conductive stationary member 524, and is further operable so as to energize the electromagnet 525 when the number of intermittent contacts counted thereby has reached a predetermined threshold, such as twenty intermittent contacts. Since integrated circuits capable of generating a count output are known in the art, further details of the circuit unit 526 will be omitted herein.

It is noted herein that detection of vehicle movement should not be limited to vibration detection. In other embodiments of this invention, the response module 52 may be designed to energize the electromagnet 525 when the former is subjected to inertial forces for a predetermined time period during movement of the vehicle. In this case, the response module 52 still includes the conductive resilient member 523, the conductive stationary member 524 and the circuit unit 526. The conductive resilient member 523 is configured to flex when subjected to the inertial forces attributed to movement of the vehicle, while the conductive stationary member 524 is contacted by the conductive resilient member 523 during flexing of the latter. On the other hand, the circuit unit 526 is operable so as to detect the duration of contact between the conductive resilient member 523 and the conductive stationary member 524, and is operable so as to energize the electromagnet 525 when the duration of contact detected thereby has reached a predetermined threshold.

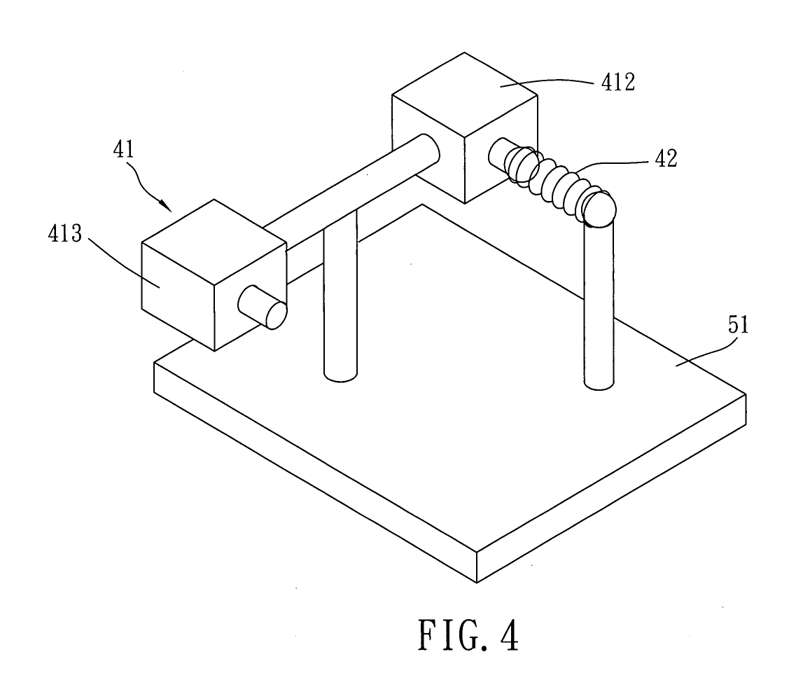

Referring to FIGS. 2 and 4, the tire-deflating unit 4 includes a depressible deflation valve 40, a striker 41, and a spring 42. The deflation valve 40 is provided at the connecting end segment 321 of the bypass duct 32. As mentioned hereinabove, the connecting end segment 321 extends into the casing 31 and is thus remote from the pneumatic tire 232 (see FIG. 1). The striker 41 is generally T-shaped and is mounted pivotally on the circuit board 51. The striker 41 has a force-actuated end 412 proximate to the electromagnet 525, and a valve-actuating end 413 proximate to the deflation valve 40. The spring 42 pulls the force-actuated end 412 to dispose the striker 41 in a normal non-deflating state shown in FIG. 2, in which the valve-actuating end 413 is spaced apart from the deflation valve 40. When the striker 41 is in the non-deflating state, the deflation valve 40 is closed, thereby preventing deflation of the pneumatic tire 232 through the bypass duct 32.

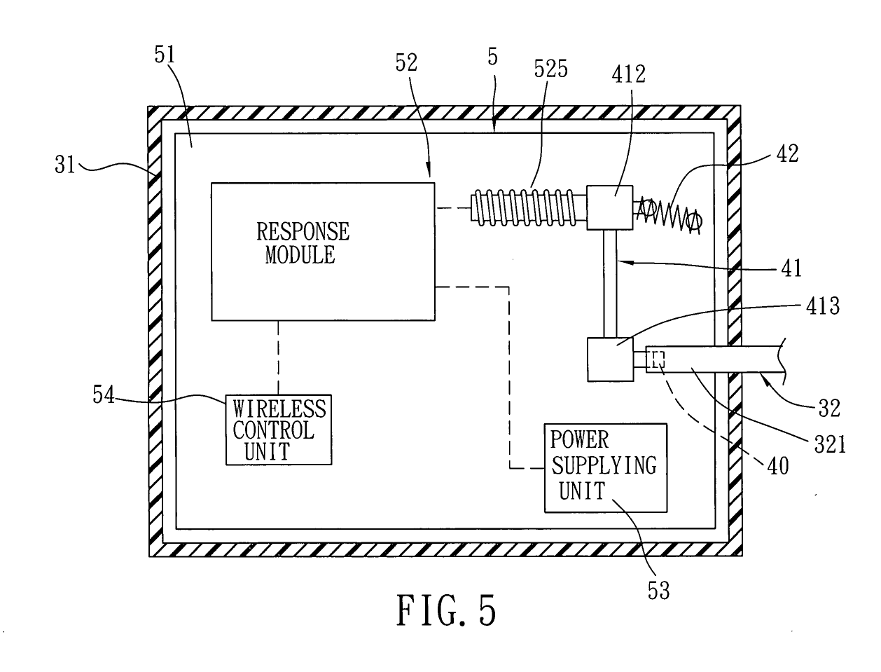

Referring to FIG. 5, when the electromagnet 525 is energized and attracts the force-actuated end 412, the striker 41 pivots to the deflating state against the biasing action of the spring 42. When the striker 41 is in the deflating state, the valve-actuating end 413 presses the deflation valve 40 for deflating the pneumatic tire 232 through the bypass duct 32.

Therefore, when the response module 52 is operated in the activated state through the wireless control unit 54, the response module 52 energizes the electromagnet 525 upon detection of vehicle movement. When energized, the electromagnet 525 attracts the force-actuated end 412 of the striker 41 to pivot the striker 41 to the deflating state, during which time the valve-actuating end 413 opens the deflation valve 40 to deflate the pneumatic tire 232 via the bypass duct 32. Because the pneumatic tire 232 is deflated, vehicle theft can be deterred accordingly.

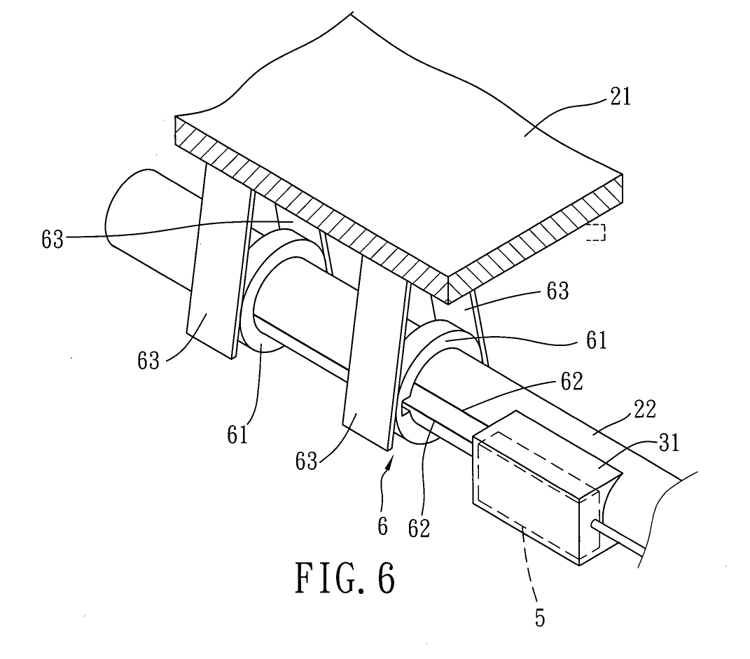

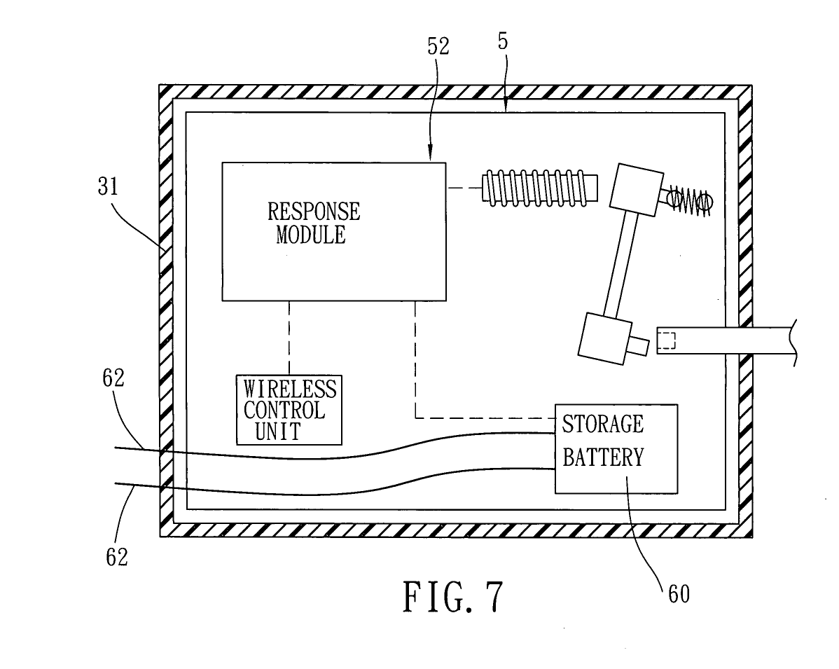

FIGS. 6 and 7 illustrate the second preferred embodiment of this invention, which differs from the first preferred embodiment in the structure of the power supplying unit 6. In this embodiment, the power supplying unit 6 includes a brush contact set 63 adapted to be connected to a vehicle power source (not shown), a ring contact set 61 adapted to be mounted on the wheel axle 22 and in sliding contact with the brush contact set 63, and a storage battery 60 connected to the deflation controller 5 and to the ring contact set 61 via a wire pair 62 that extends into the casing 31. In this embodiment, the vehicle power source can be used to recharge the storage battery 60.

In a modification of the second preferred embodiment, the storage battery 60 may be dispensed with, and electric power from the vehicle power source may be supplied instead to the deflation controller 5 via the brush contact set 63, the ring contact set 61, and the wire pair 62.

In another modification of the first and second preferred embodiments, activation and deactivation of the response module 52 could be conducted without using the wireless control unit 54. In particular, by providing a switch (not shown) at an appropriate location of the vehicle, such as close to a steering wheel of the vehicle, the supply of electric power to the response module 52 could be controlled to activate or deactivate the response module 52 as desired.

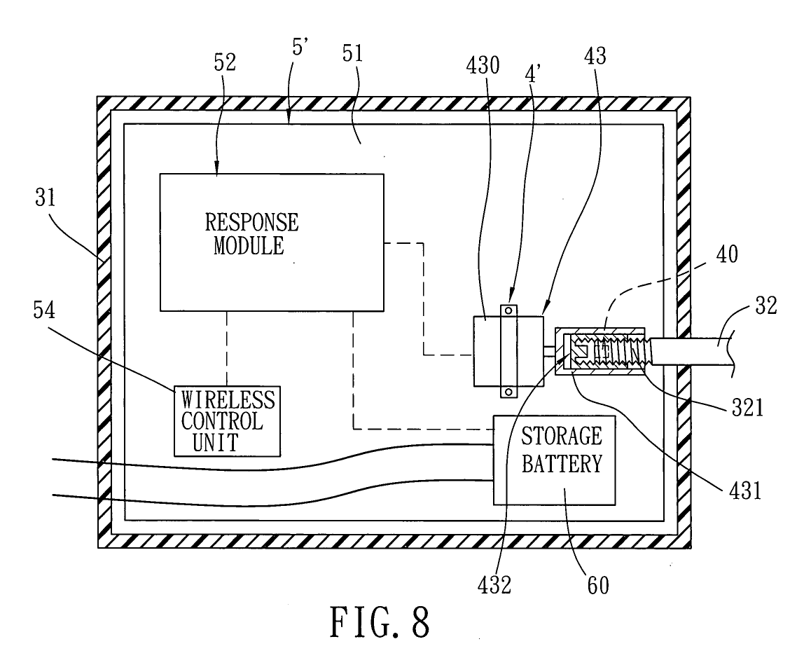

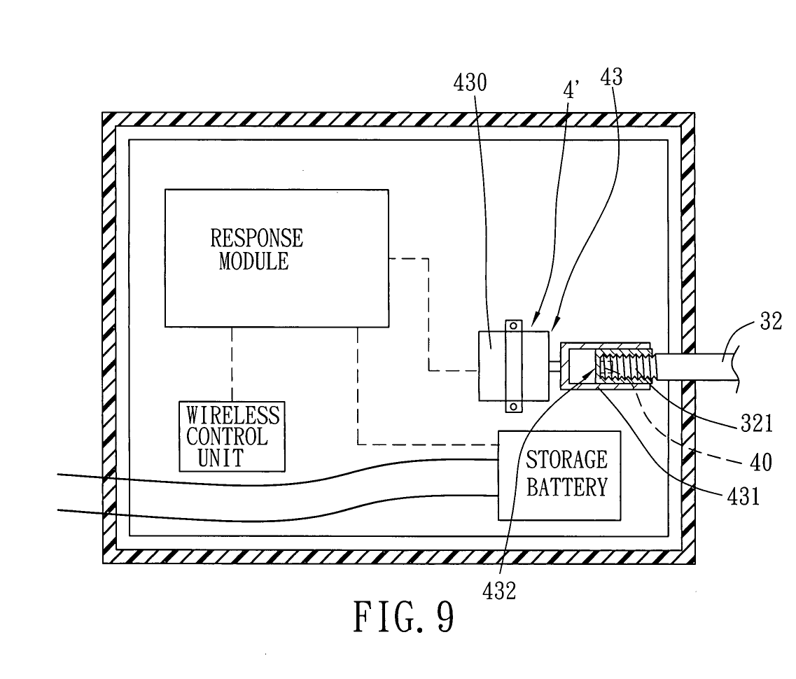

Referring to FIG. 8, the third preferred embodiment of this invention differs from the second preferred embodiment in that the electromagnet 525 is omitted from the deflation controller 5′, and that the tire-deflating unit 4′ includes the depressible deflation valve 40, a valve actuator 432, and a motor unit 43. The connecting end segment 321 of the bypass duct 32, which extends into the casing 31 and which is remote from the pneumatic tire 232 (see FIG. 1), is formed with an external thread. The deflation valve 40 is provided at the connecting end segment 321 of the bypass duct 32. The valve actuator 432 is mounted threadedly on the connecting end segment 321 of the bypass duct 32. The motor unit 43 is coupled to the response module 52 of the deflation controller 5′ and to the valve actuator 432. The motor unit 43 is activated by the response module 52 of the deflation controller 5′ to drive movement of the valve actuator 432 so as to enable the valve actuator 432 to press the deflation valve 40 (see FIG. 9) for deflating the pneumatic tire 232 through the bypass duct 32 when the deflation controller 5′ detects movement of the vehicle while the response module 52 is in the activated state. The response module 52 controls the motor unit 43 for moving the valve actuator 432 in the opposite direction upon subsequent deactivation of the response module 52.

In this embodiment, the motor unit 43 includes a motor 430 mounted on the circuit board 51, and a drive sleeve 431 driven rotatably the motor 430. The valve actuator 432 extends slidably into the drive sleeve 431 and is coupled co-rotatably thereto, such as by providing the drive sleeve 431 and the valve actuator 432 with complementary non-circular (e.g., polygonal) confronting surfaces.

In other embodiments, the tire-deflating unit may be modified to include a coupling mechanism, such as a rack-and-pinion mechanism or a cam mechanism, between the motor and the valve actuator that is mounted slidably on the connecting end segment 321 of the bypass duct 32.

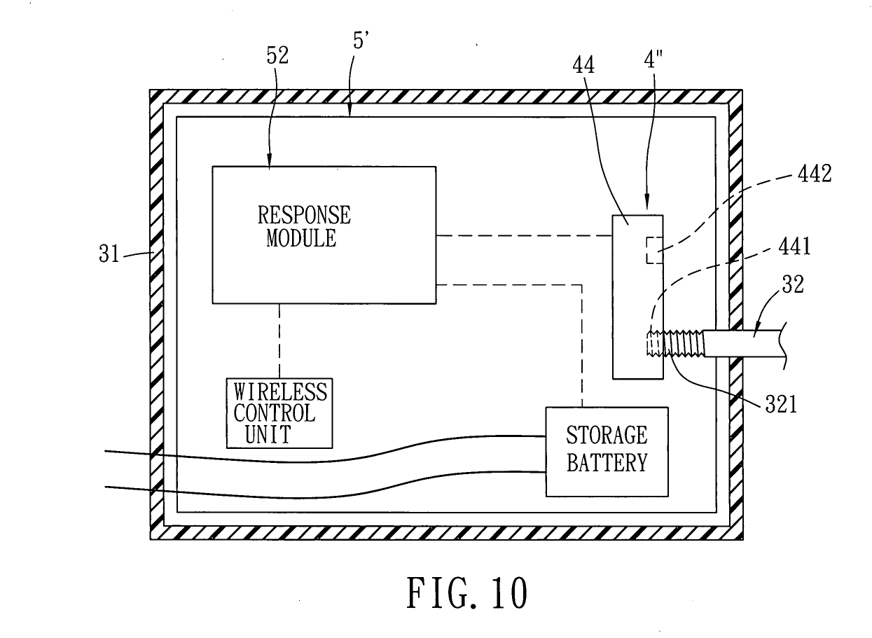

Referring to FIG. 10, the fourth preferred embodiment of this invention is shown to differ from the third preferred embodiment in that the tire-deflating unit 4″ includes a solenoid valve unit 44 having an inlet port 441 connected to the connecting end segment 321 of the bypass duct 32, and an outlet port 442. The solenoid valve unit 44 is coupled to and controlled by the response module 52 of the deflation controller 5′ between non-deflating and deflating states. When the solenoid valve unit 44 is in the non-deflating state, airflow between the inlet and outlet ports 441, 442 is blocked so that deflating of the pneumatic tire 232 (see FIG. 1) via the bypass duct 32 is prevented. On the other hand, when the solenoid valve unit 44 is in the deflating state, airflow between the inlet and outlet ports 441, 442 is permitted so that the pneumatic tire 232 can be deflated through the bypass duct 32 when the response module 52 of the deflation controller 5′ detects movement of the vehicle while the response module 52 is in the activated state. Since the feature of this invention does not reside in the specific construction of the solenoid valve unit 44, which is known in the art, further details of the same are omitted herein for the sake of brevity.

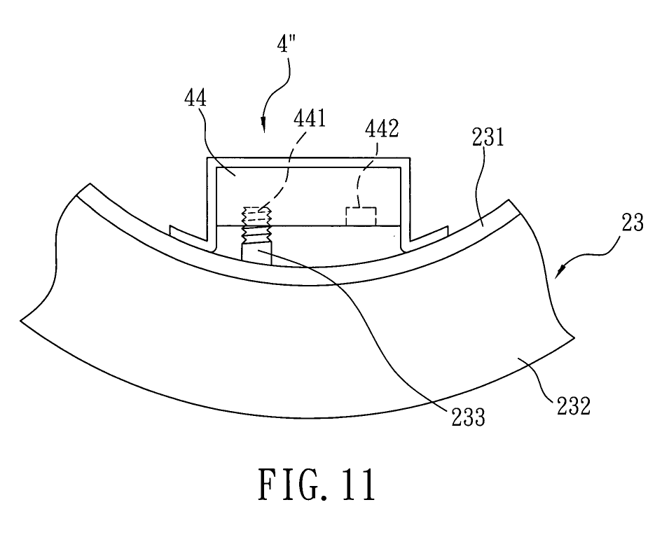

Referring to FIG. 11, the fifth preferred embodiment of this invention is shown to differ from the fourth preferred embodiment in that there is no bypass duct 32 and that the solenoid valve unit 44 of the tire-deflating unit 4″ is not disposed in the casing 31 (see FIG. 10) and is mounted instead on the wheel rim 231 of the vehicle wheel 23. The inlet port 441 of the solenoid valve unit 44 is connected to the tire valve 233 on the vehicle wheel 23 such that the tire valve 233 is in an opened state. Coupling between the solenoid valve unit 44 and the response module 52 of the deflation controller 5′ (see FIG. 10) could be achieved through conventional wireless control techniques. Therefore, the solenoid valve unit 44 can be controlled by the deflation controller 5′ for deflating the pneumatic tire 232 through the tire valve 233 and the solenoid valve unit 44 when the deflation controller 5′ detects movement of the vehicle while the deflation controller 5′ is in the activated state.

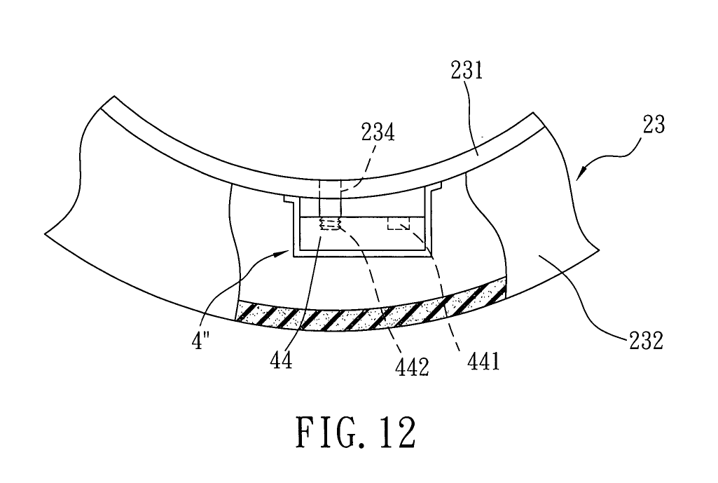

Referring to FIG. 12, the sixth preferred embodiment of this invention is shown to differ from the fifth preferred embodiment in that the solenoid valve unit 44 of the tire-deflating unit 44″ is mounted on the wheel rim 231 inside the pneumatic tire 232. The inlet port 441 of the solenoid valve unit 44 is in fluid communication with the air-containing space of the vehicle wheel 23. The outlet port 442 of the solenoid valve unit 44 is in fluid communication with the ambient via a connecting conduit 234 that extends through the wheel rim 231. The solenoid valve unit 44 is coupled to and controlled by the deflation controller 5′ (see FIG. 10) in a manner similar to that of the fifth preferred embodiment.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. An anti-theft device for a vehicle having a wheel axle and a vehicle wheel that includes a wheel rim coupled co-rotatably to the wheel axle, and a pneumatic tire mounted on the wheel rim, said anti-theft device comprising:
a tire-deflating unit adapted to be coupled to the vehicle wheel, and operable in a deflating state for deflating the pneumatic tire; and
a deflation controller coupled to said tire-deflating unit, and operable in an activated state, in which said deflation controller detects movement of the vehicle and enables operation of said tire-deflating unit in the deflating state upon detecting movement of the vehicle.

2. The anti-theft device as claimed in claim 1, further comprising a bypass duct adapted to interconnect fluidly said tire-deflating unit and the pneumatic tire.

3. The anti-theft device as claimed in claim 2, wherein said bypass duct has a coupling end segment adapted to connect the pneumatic tire to a tire valve.

4. The anti-theft device as claimed in claim 2, further comprising a casing that houses said tire-deflating unit and said deflation controller therein and that is adapted to be mounted on the wheel axle.

5. The anti-theft device as claimed in claim 2, wherein said deflation controller includes:
an electromagnet capable of being energized so as to generate magnetic forces for operating said tire-deflating unit in the deflating state; and
a response module coupled to said electromagnet and operable so as to energize said electromagnet in response to movement of the vehicle.

6. The anti-theft device as claimed in claim 5, wherein said deflation controller further includes a wireless control unit coupled to said response module and controlling activation and deactivation of said response module in response to wirelessly transmitted control signals received thereby.

7. The anti-theft device as claimed in claim 5, wherein said response module energizes said electromagnet when said response module is subjected to a predetermined number of vibrations during movement of the vehicle.

8. The anti-theft device as claimed in claim 7, wherein said response module includes:
a conductive resilient member capable of reciprocating flexing movement when subjected to the vibrations attributed to movement of the vehicle;
a conductive stationary member spaced apart from said conductive resilient member and intermittently contacted by said conductive resilient member during reciprocating flexing movement of said conductive resilient member; and
a circuit unit coupled electrically to said conductive resilient member and said conductive stationary member, operable so as to count number of intermittent contacts between said conductive resilient member and said conductive stationary member, and operable so as to energize said electromagnet when the number of intermittent contacts counted thereby has reached a predetermined threshold.

9. The anti-theft device as claimed in claim 5, wherein said response module energizes said electromagnet when said response module is subjected to inertial forces for a predetermined time period during movement of the vehicle.

10. The anti-theft device as claimed in claim 9, wherein said response module includes:
a conductive resilient member capable of flexing when subjected to the inertial forces attributed to movement of the vehicle;
a conductive stationary member spaced apart from said conductive resilient member and contacted by said conductive resilient member during flexing of said conductive resilient member; and
a circuit unit coupled electrically to said conductive resilient member and said conductive stationary member, operable so as to detect duration of contact between said conductive resilient member and said conductive stationary member, and operable so as to energize said electromagnet when the duration of contact detected thereby has reached a predetermined threshold.

11. The anti-theft device as claimed in claim 5, wherein said tire-deflating unit includes:
a depressible deflation valve provided at one end of said bypass duct remote from the pneumatic tire; and
a striker having a force-actuated end proximate to said electromagnet, and a valve-actuating end proximate to said deflation valve;
said striker being movable so as to cause said valve-actuating end to press said deflation valve for deflating the pneumatic tire through said bypass duct when said electromagnet is energized and attracts said force-actuated end.

12. The anti-theft device as claimed in claim 1, further comprising a power supplying unit for supplying electric power to said deflation controller, said power supplying unit including a brush contact set adapted to be connected to a power source of the vehicle, and a ring contact set adapted to be mounted on the wheel axle and in sliding contact with said brush contact set.

13. The anti-theft device as claimed in claim 12, wherein said power supplying unit further includes a storage battery connected to said deflation controller and said ring contact set.

14. The anti-theft device as claimed in claim 2, wherein said tire-deflating unit includes:
a depressible deflation valve provided at one end of said bypass duct remote from the pneumatic tire;
a valve actuator mounted movably on said one end of said bypass duct; and
a motor unit coupled to said deflation controller and said valve actuator, said motor unit being activated by said deflation controller to drive movement of said valve actuator so as to enable said valve actuator to press said deflation valve for deflating the pneumatic tire through said bypass duct when said deflation controller detects movement of the vehicle while said deflation controller is in the activated state.

15. The anti-theft device as claimed in claim 2, wherein said tire-deflating unit includes a solenoid valve unit connected to one end of said bypass duct remote from the pneumatic tire, said solenoid valve unit being coupled to and controlled by said deflation controller for deflating the pneumatic tire through said bypass duct when said deflation controller detects movement of the vehicle while said deflation controller is in the activated state.

16. The anti-theft device as claimed in claim 1, wherein said tire-deflating unit includes a solenoid valve unit adapted to be connected to a tire valve on the vehicle wheel such that the tire valve is in an opened state, said solenoid valve unit being coupled to and controlled by said deflation controller for deflating the pneumatic tire through the tire valve and said solenoid valve unit when said deflation controller detects movement of the vehicle while said deflation controller is in the activated state.

17. The anti-theft device as claimed in claim 1, wherein said tire-deflating unit includes a solenoid valve unit adapted to be mounted on the wheel rim inside the pneumatic tire, said solenoid valve unit being coupled to and controlled by said deflation controller for deflating the pneumatic tire when said deflation controller detects movement of the vehicle while said deflation controller is in the activated state.
